(19) United States
(12) Patent Application Publication
(10) Pub. No.: US 2010/0316306 A1
(43) Pub. Date: Dec. 16, 2010

(54) INFORMATION PROCESSING APPARATUS AND INFORMATION PROCESSING METHOD

(75) Inventor: Takeshi Matsushita, Fujisawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/795,394

(22) Filed: Jun. 7, 2010

(30) Foreign Application Priority Data
Jun. 15, 2009 (JP) 2009-142709

(51) Int. Cl. G06K 9/54

(52) U.S. Cl. 382/305

(57) ABSTRACT

The information processing apparatus stores a file containing image data and supplementary image data generated based on a region that is at least a portion of the image, compares the image data and the supplementary image data and detects which region of the image the supplementary image was generated based on, generates a second file containing information indicating the region that was detected and the size of the supplementary image, generates a first file by deleting the supplementary image data from the file, and transmits the first file and the second file instead of transmitting the file. The peripheral apparatus receives the first file and the second file, generates the supplementary image data from the image data contained in the first file with use of the information indicating the region and the size of the supplementary image, and generates a third file having the same configuration as the file.

### BACKGROUND OF THE INVENTION

1. Field of the Invention

The present invention relates to an information processing apparatus and an information processing method for processing a file containing multiple pieces of image data.

2. Description of the Related Art

The idea of collectively handling multiple pieces of image data in a single file is a conventional idea. Japanese Patent Laid-open No. 2008-167067 discloses an image recording method that enables easy referencing of related information of multiple pieces of image data. Japanese Patent Laid-open No. 11-266420 discloses an image recording method in which compressed image data for recording that has been generated in one instance of a recording operation is a single piece of combined data including independent image data pieces.

Also, ideas for reducing the amount of data that is transferred during the transfer of image data containing a thumbnail image have been proposed. Japanese Patent Laid-open No. 2003-204500 discloses a transfer method in which a main image and thumbnail image are compared, and if the size difference between the main image and the thumbnail image is small, the main image file is transferred without attaching the thumbnail image. Japanese Patent Laid-open No. 2005-117228 discloses a transfer method in which an image server receives an image file attached to an electronic mail from a mobile phone, and generates image data with a thumbnail attached by generating a thumbnail image from the received image and attaching the thumbnail to the received image.

Here, consider an image file that is a single file containing a main image and a thumbnail image (supplementary image) for display on a monitor, likewise to Japanese Patent Laid-open Nos. 2008-167067 and 11-266420. Up to only 64 kilobytes of image data can be held as a thumbnail image in a conventional Exif file. However, with the image files in the aforementioned Patent Literature, image data for display on a monitor that is larger in size and has a higher image quality than a thumbnail image in an Exif file can be held as the supplementary data.

Now consider the case in which an image file having a format such that main image data (hereinafter, simply referred to as “image data”) and supplementary image data for display on a monitor are held in a single file is transmitted outside the apparatus. In such a case, compared to the transfer of a conventional file containing only main image data, the amount of data transmitted increases by the amount of data in the supplementary image data.

### SUMMARY OF THE INVENTION

An aspect of the present invention is to eliminate the above-mentioned problems with the conventional technology.

The present invention provides an information processing apparatus and an information processing method that suppress an increase in the amount of data transmitted when a file containing image data and supplementary image data is transmitted.

The present invention in its first aspect provides an information processing apparatus including a transmission unit configured to transmit to a peripheral apparatus a file containing image data expressing an image and supplementary image data expressing a supplementary image generated based on a region that is at least a portion of the image, the information processing apparatus comprising:

a storage unit configured to store the file;

a second generation unit configured to compare the image data and the supplementary image data and detect which region of the image the supplementary image was generated based on, and generate a second file containing information indicating the region that was detected and a size of the supplementary image; and

a first generation unit configured to generate a first file by deleting the supplementary image data from the file,

wherein the transmission unit transmits the first file and the second file instead of transmitting the file.

The present invention in its second aspect provides an information processing system comprising an information processing apparatus including a transmission unit configured to transmit to a peripheral apparatus a file containing image data expressing an image and supplementary image data expressing a supplementary image generated based on a region that is at least a portion of the image, and a peripheral apparatus capable of receiving the file transmitted from the transmission unit of the information processing apparatus,

the information processing apparatus comprising:

a storage unit configured to store the file;

a second generation unit configured to compare the image data and the supplementary image data and detect which region of the image the supplementary image was generated based on, and generate a second file containing information indicating the region that was detected and a size of the supplementary image; and

a first generation unit configured to generate a first file by deleting the supplementary image data from the file,

wherein the transmission unit transmits the first file and the second file to the peripheral apparatus instead of transmitting the file, and

the peripheral apparatus comprising:

a reception unit configured to receive the first file and the second file; and

a third generation unit configured to generate the supplementary image data from the image data contained in the first file with use of the information indicating the region and the size of the supplementary image that are contained in the second file, and generate a third file having the same configuration as the file by attaching the supplementary image data to the first file.

The present invention in its third aspect provides an information processing method executed in an information processing system comprising an information processing apparatus that transmits to a peripheral apparatus a file containing image data expressing an image and supplementary image data expressing a supplementary image generated based on a region that is at least a portion of the image, and a peripheral apparatus capable of receiving the file transmitted from the information processing apparatus, the information processing method comprising the steps of:

in the information processing apparatus,

comparing the image data and the supplementary image data and detecting which region of the image the supplementary image was generated based on, and generating a second file containing information indicating the region that was detected and a size of the supplementary image;

generating a first file by deleting the supplementary image data from the file; and

transmitting the first file and the second file to the peripheral apparatus instead of transmitting the file, and

in the peripheral apparatus,

receiving the first file and the second file; and

generating the supplementary image data from the image data contained in the first file with use of the information indicating the region and the size of the supplementary image that are contained in the second file, and generating a third file having the same configuration as the file by attaching the supplementary image data to the first file.

According to the present invention, when a file containing image data and supplementary image data is transmitted, an increase in the amount of data transmitted can be suppressed since the supplementary image data is not transmitted.

Further features of the present invention will become apparent from the following description of exemplary embodiments with reference to the attached drawings.

### BRIEF DESCRIPTION OF THE DRAWINGS

FIG. 1 is a diagram showing a schematic configuration of a system according to an embodiment of the present invention.

FIG. 2 is a diagram showing a schematic configuration of an apparatus used in the embodiment of the present invention.

FIG. 3 is a diagram showing a configuration of a file on which transmission processing is performed.

FIG. 4 is a diagram illustrating a clipping region.

FIG. 5 is a diagram showing a procedure of processing executed in an apparatus that is the transmission source.

FIG. 6 is a diagram showing a configuration of a supplementary image reproduction information file.

FIGS. 7A to 7G are diagrams illustrating the acquisition of a clipping region.

FIG. 8 is a diagram showing a configuration of a file that is transmitted.

FIG. 9 is a diagram showing a procedure of processing executed in an apparatus that is the transmission destination.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals have been given to constituent elements that are the same, and descriptions thereof will not be given.

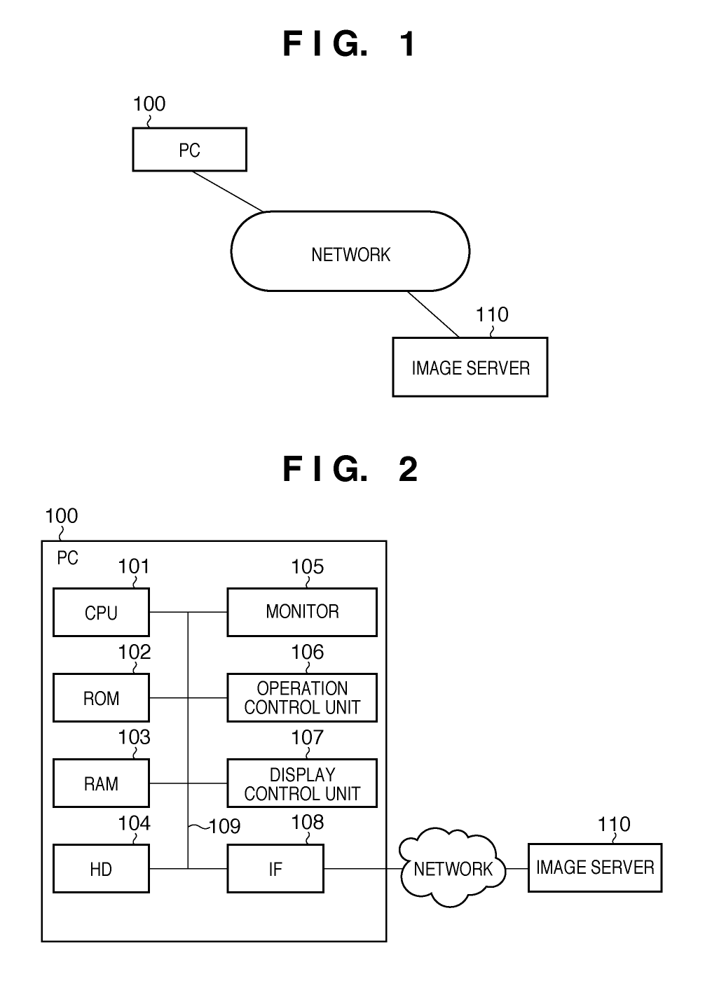

FIG. 1 shows a schematic configuration of an information processing system described in the present embodiment. In the present embodiment, a case is considered in which a file, which is a single file containing image data and supplementary image data and is described later, is transferred from a PC 100 that is the transfer source to an image server 110 that is the transfer destination, via a network. Note that in the present embodiment, the PC 100 and the image server 110 are connected via a wireless network. However, the form of the network is not limited to this, and any form of network that enables the transfer of files between the above two devices can be employed.

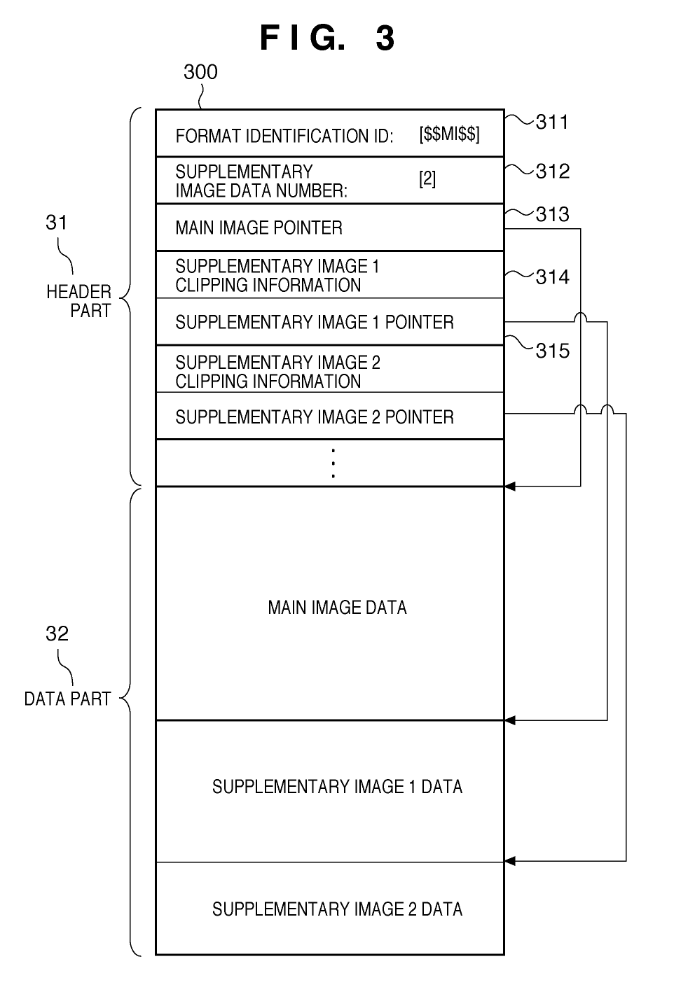

FIG. 2 is a block diagram showing a configuration of the information processing apparatus used in the present embodiment. The PC 100 that is the information processing apparatus is connected to the image server 110 via a network such that bidirectional communication is possible. The PC 100 includes a CPU 101 that controls constituent elements in the PC 100 based on programs in an OS or the like that is basic software, and a ROM 102 that records, for example, programs executed at the time of startup of the PC 100. The PC 100 also includes a RAM 103 that is used as a buffer area for a work area necessary in the execution of programs, an HD (hard disk) 104 that stores the OS, application software, and various types of data, and a monitor 105 that visually displays various types of information. The PC 100 furthermore includes an operation control unit 106 that detects input operations performed by a user via an input device such as a keyboard or a mouse, and performs control according to the input operations, and a display control unit 107 that controls the display of various types of information on the monitor 105. The PC 100 still further includes an IF (interface) 108 for performing the transmission and reception of various types of data with an external apparatus such as the image server 110. The above constituent elements are connected to each other via a bus 109 such that data can be transmitted and received. Also, although not particularly shown, the PC 100 also includes, for example, an optical disc drive capable of reading and writing data from/to a CD or DVD, and an input device such as a keyboard or a mouse. The configuration of the image server 110 is the same as the configuration shown in FIG. 2.

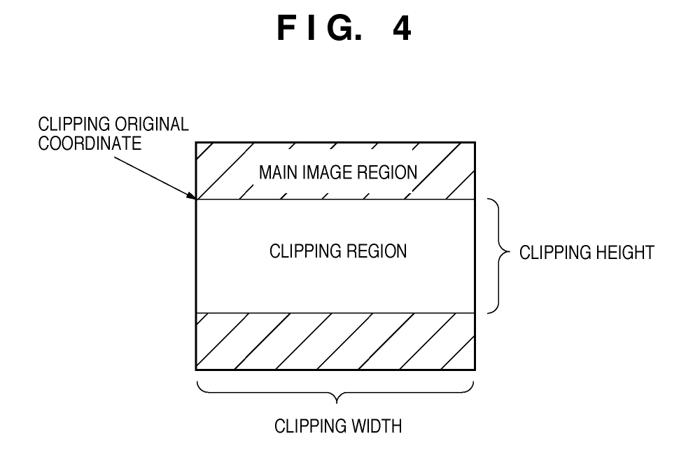

FIG. 3 is a diagram showing a configuration of a file that stores main image data and one or more pieces of supplementary image data, and that enables the generation of supplementary image data from the main image data. In the following description, such a file is referred to as a file storing multiple images. A file storing multiple images 300 is comprised of mainly two parts, namely a header part 31 and a data part 32. The header part 31 includes a format identification ID 311 for identifying the file format, and a supplementary image data number 312 indicating the number of supplementary image data pieces contained in the file. The header part 31 also includes a main image data pointer 313 that indicates the head address of the main image data, supplementary image clipping information 314, and supplementary image pointers 315 that indicate the head addresses of the supplementary image data pieces.

The format identification ID 311 is embedded as an ASCII code at the head of the file storing multiple images 300. For example, if the format identification ID for the format described here is the six-byte character string “$$MI$$”, when file analysis is performed, a determination is made as to whether the first six bytes of the file are “$$MI$$”. As a result, it is easy to distinguish whether the file format is the format for storing multiple images.

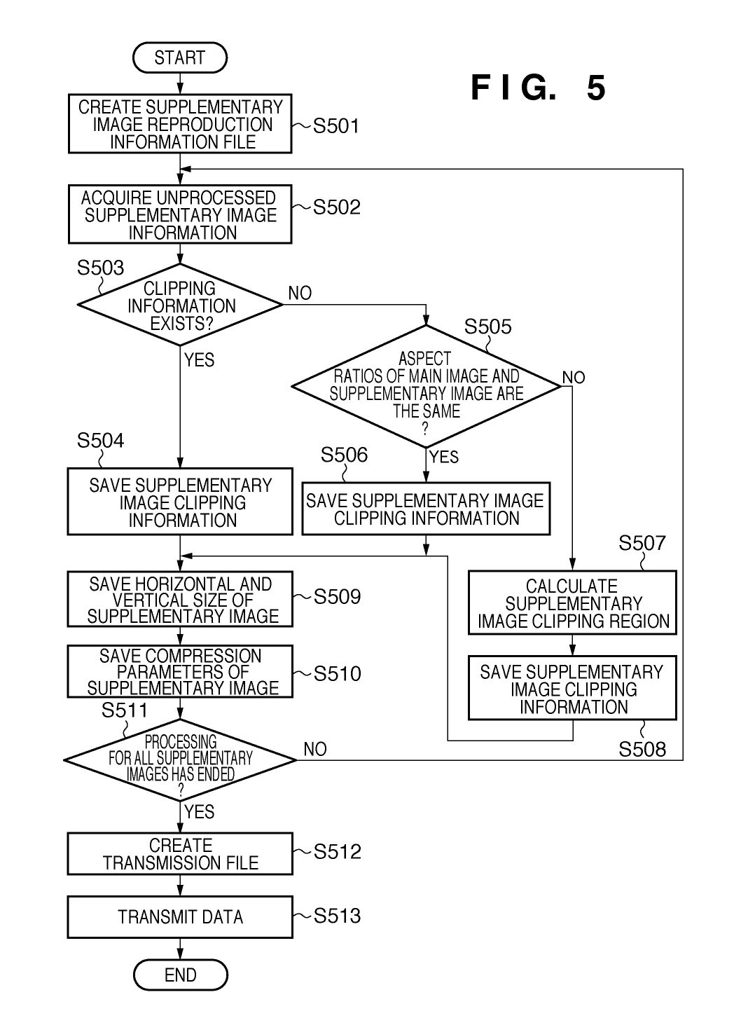

Each piece of supplementary image clipping information 314 expresses information regarding which region of the main image was clipped (designated) and set as a supplementary image region when the corresponding supplementary image data was generated from the main image data. As shown in FIG. 4, the supplementary image clipping information 314 includes a clipping origin coordinate, a clipping width, and a clipping height. In the present embodiment, the clipping region is a rectangular region that is at least a portion of the main image, as shown in FIG. 4. The clipping origin coordinate expresses the top left coordinates of the clipping region with respect to the main image region. Also, the clipping width expresses the width of the clipping region from the origin coordinate. The clipping height expresses the height of the clipping region from the origin coordinate.

Here, if the supplementary image is a region obtained by reducing the size of a region clipped from the main image, there is no particular need for a clipping region designation in the supplementary image clipping information 314. In such a case, information indicating that a clipping region is not set may be stored in the supplementary image clipping information 314. Also, the supplementary image clipping information 314 may be omitted. A piece of supplementary image clipping information 314 and a supplementary image pointer 315 exist for each supplementary image. In the example shown in FIG. 3, two supplementary images exist, namely a supplementary image 1 and a supplementary image 2, and therefore two sets of information are stored, each including a piece of supplementary image clipping information 314 and a supplementary image pointer 315.

The data part 32 stores image data of the main image and the supplementary images. In the present embodiment, the main image data and the supplementary image data are in the JPEG format. In this case, the horizontal and vertical number of pixels in the main image data and the horizontal and vertical number of pixels in the supplementary image data pieces can be acquired from information in the JPEG header of the main image data and the supplementary image data pieces.

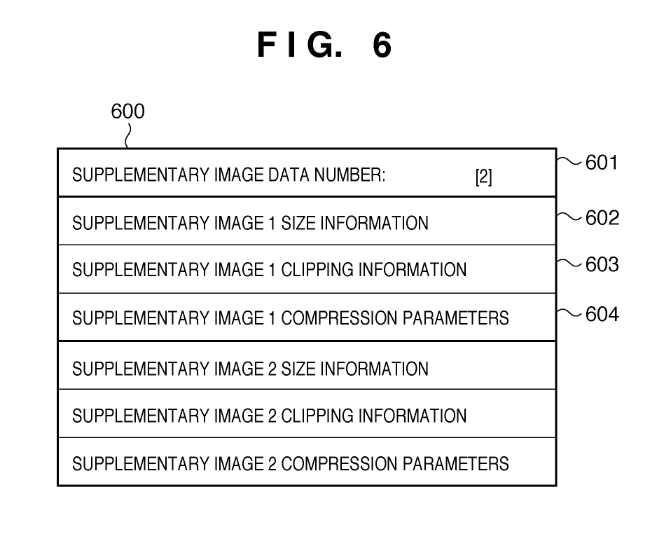

Next is a description of a procedure of processing performed in the PC 100 that is the transmission source of the file storing multiple images 300, with reference to FIG. 5. The processing shown in FIG. 5 is executed by, for example, the CPU 101 in the PC 100.

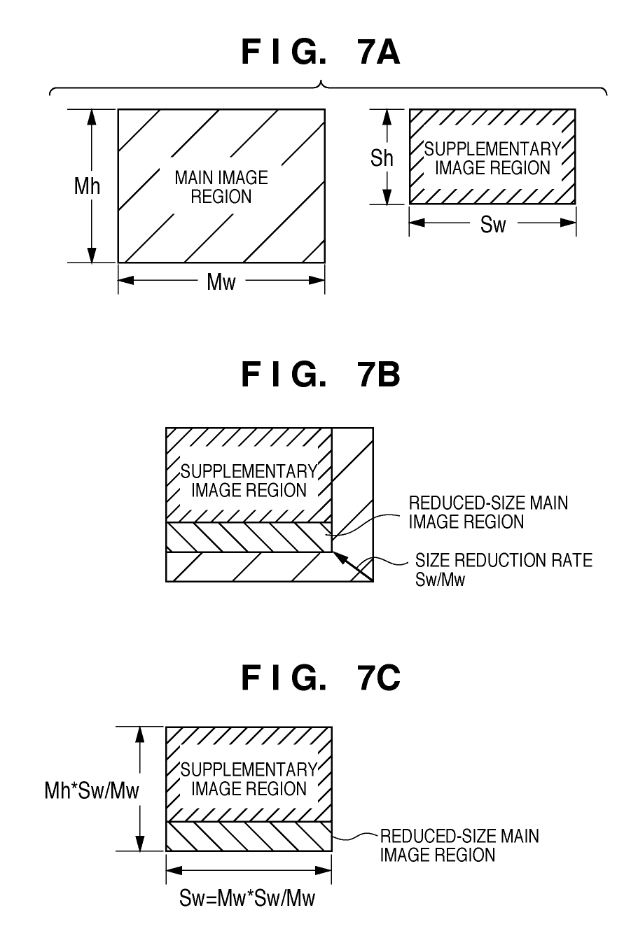

First, if a user has given an instruction to transmit the file storing multiple images 300, a supplementary image reproduction information file 600 for storing information regarding deleted supplementary images is generated (S501). In the present embodiment, the supplementary image reproduction information file 600 corresponds to a second file, and the processing of S501 for generating the second file corresponds to second generation processing. A first file and first generation processing are described later. As shown in FIG. 6, the supplementary image reproduction information file 600 includes a supplementary image data number 601, supplementary image size information 602, supplementary image clipping information 603, and supplementary image compression parameters 604. The supplementary image data number 601 indicates the number of deleted supplementary images. Each piece of supplementary image size information 602 indicates the horizontal and vertical size (number of pixels) in the corresponding deleted supplementary image. The supplementary image clipping information 603 is as described above. Each of the supplementary image compression parameters 604 indicates parameters for determining image quality when converting the corresponding supplementary image into JPEG data, for example. In the present embodiment, a quantization table and color sampling numbers are used as the supplementary image compression parameters. Both of these are information that can be acquired from the header in the JPEG file. The supplementary image size information 602, the supplementary image clipping information 603, and the supplementary image compression parameters 604 are provided for each supplementary image. In the example shown in FIG. 6, the supplementary image 1 and the supplementary image 2 are the deleted supplementary images, and the supplementary image size information 602, the supplementary image clipping information 603, and the supplementary image compression parameters 604 exist for each of these supplementary images. In S501, the supplementary image data number 312 of the file storing multiple images 300 is referenced, and the supplementary image reproduction information file 600, whose size corresponds to the number of supplementary images, is created. At this time, only the supplementary image data number 601 is set in the supplementary image reproduction information file 600, and the other items have not be set yet. Information is set for these unset items according to a processing flow described later.

Next, the supplementary image clipping information of unprocessed supplementary images and the supplementary image data pieces expressing such supplementary images are acquired from the file storing multiple images 300 (S502). In S503, a determination is made as to whether supplementary image clipping information was acquired in S502. Here, if a determination is made that supplementary image clipping information was acquired, the procedure proceeds to S504, and the supplementary image clipping information acquired in S502 is stored in the supplementary image clipping information 603 of the supplementary image reproduction information file 600. On the other hand, if a determination that supplementary image clipping information was not acquired (in other words, is not set) is made in S503, the procedure proceeds to S505, and a determination is made as to whether the horizontal/vertical aspect ratio of the main image and the horizontal/vertical aspect ratio of the supplementary image are the same. Such a determination may be made based on the above-described horizontal and vertical number of pixels in the main image data and the supplementary image data in the JPEG headers.

If a determination that the aspect ratios are the same is made in S505, in S506 the supplementary image is considered to have been generated by reducing the size of the entire main image region without performing other processing. In other words, in the supplementary image clipping information, the top left coordinates (0,0) of the main image are set as the clipping origin coordinate, and the horizontal and vertical number of pixels in the main image are set as the clipping width and height. Such information is stored in the supplementary image clipping information 603 of the supplementary image reproduction information file 600. On the other hand, if a determination that the aspect ratios are not the same is made in S505, the procedure proceeds to S507.

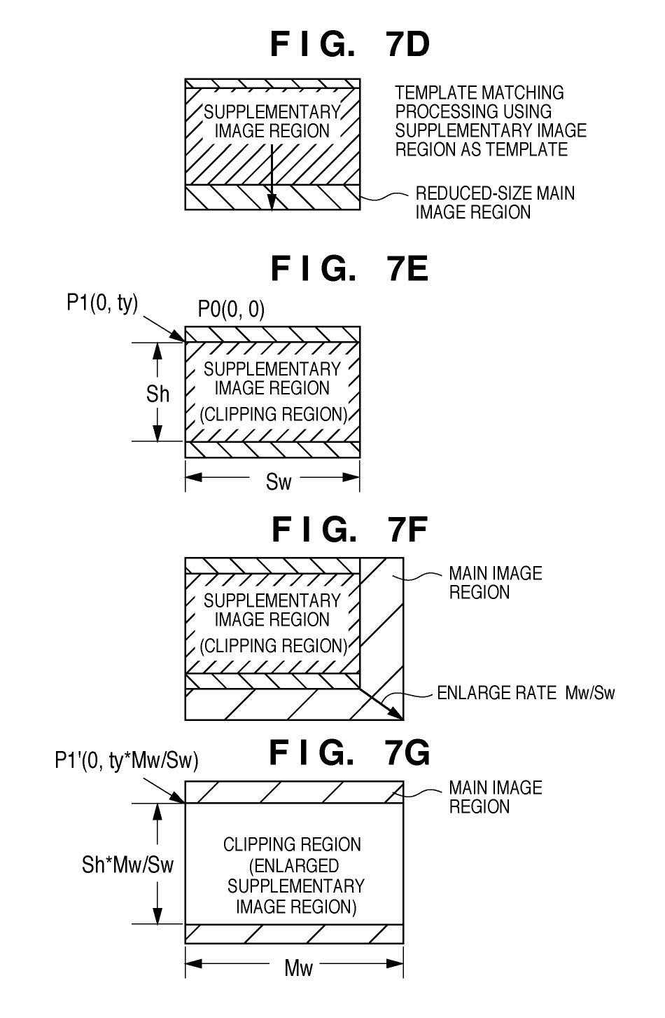

Next is a description of the acquisition of the supplementary image clipping region in S507, with reference to FIGS. 7A to 7G. The following description is based on the assumption of the case of a main image region having a width Mw and a height Mh, and a supplementary image region having a width Sw and a height Sh, as shown in FIG. 7A.

First, as shown in FIG. 7B, a reduced-size main image region is generated by reducing the size of the main image region to a minimum size in which the supplementary image region can fit, while maintaining the aspect ratio of the main image. In the present example, since (Sw/Mw)>(Sh/Mh), the size of the main image region is reduced to a size at which the width is Sw, while maintaining the aspect ratio, and thus the reduced-size main image region is created. In this case, the size reduction rate is Sw/Mw, and as shown in FIG. 7C, the width of the reduced-size main image region is equal to Sw according to Mw×Sw/Mw, and the height is Mh×Sw/Mw.

Next, as shown in FIG. 7D, template matching processing is performed on the reduced-size main image region with use of the supplementary image region, and from which region of the reduced-size main image region the supplementary image region was actually clipped is detected. FIG. 7E shows that in the case where an origin P0 (0,0) is the top left of the reduced-size main image region, P1 (0,ty) is detected as the clipping origin coordinate.

Lastly, which region in the actual main image the clipping region in the reduced-size main image region corresponds to is calculated by enlarging the reduced-size main image region to the size of the original main image region. In this case, the enlargement rate is Mw/Sw, as shown in FIG. 7F. Accordingly, the enlarged supplementary image region obtained by enlarging the supplementary image region is the supplementary image clipping region in the main image. Specifically, as shown in FIG. 7G, the clipping region has a clipping origin coordinate P1′ (0,ty×Mw/Sw), a clipping width Mw, and a clipping height Sh×Mw/Sw. Then, the information regarding the supplementary image clipping region calculated in S507 is saved in the supplementary image clipping information 603 of the supplementary image reproduction information file 600 (S508).

Accordingly, S504, S506, or S508 is performed, and thereafter the procedure proceeds to S509. In S509, the horizontal and vertical number of pixels in the acquired supplementary image is stored in the supplementary image size information 602 of the supplementary image reproduction information file 600.

In S510, the supplementary image compression parameters are acquired from the header of the supplementary image data and stored in the supplementary image compression parameters 604 of the supplementary image reproduction information file 600. In S511, a determination is made as to whether the processing of S502 to S510 has been performed for all the supplementary images in the file storing multiple images 300. If a determination is made that such processing has ended for all the supplementary images, the procedure proceeds to S512, and if a determination is made that such processing has not ended for all the supplementary images (in other words, an unprocessed supplementary image exists), the procedure returns to S502.

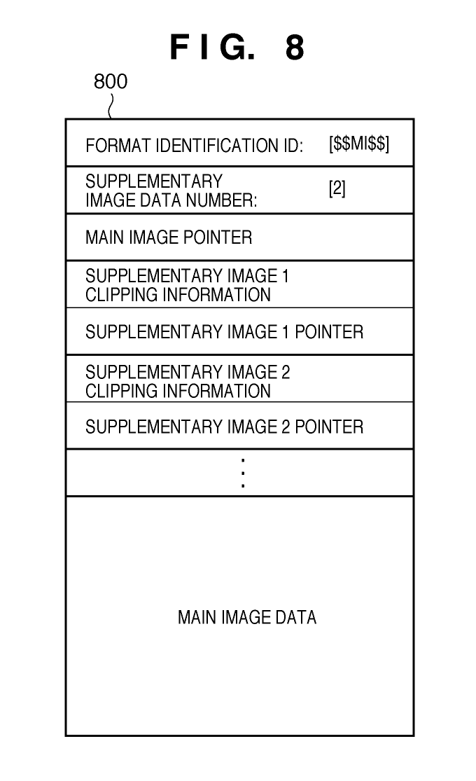

According to the series of processing up to this point, all the necessary information is stored in the supplementary image reproduction information file 600. In S512, a transmission file (corresponds to the first file) is generated (corresponds to the first generation processing). The transmission file is generated by simply deleting the supplementary image data portion from the file storing multiple images 300. FIG. 8 shows an example in which a transmission file 800 has been generated from the file storing multiple images 300 shown in FIG. 3. The supplementary image 1 data and the supplementary image 2 data have simply been deleted from the file storing multiple images 300 shown in FIG. 3. Lastly, the transmission file 800 that has been created and the supplementary image reproduction information file 600 are transmitted to the transmission destination (S513), and processing at the transmission source ends.

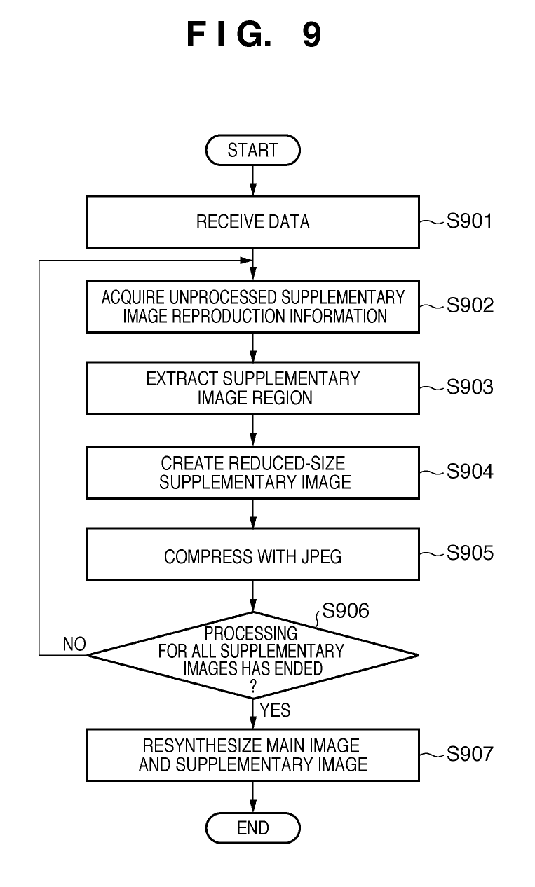

Next is a description of the procedure of processing performed in the image server 110 that is the transmission destination, with reference to FIG. 9. The processing shown in FIG. 9 is executed by, for example, the CPU 101 in the image server 110. First, in S901 the transmission file 800 and the supplementary image reproduction information file 600 that were sent from the transmission source PC 100 are received. Next, the supplementary image reproduction information file 600 is referenced, and if a supplementary image that has not been reproduced exists, the corresponding supplementary image size information 602, supplementary image clipping information 603, and supplementary image compression parameters 604 are acquired (S902). Subsequently, a supplementary image region is extracted from the main image region of the main image data in the transmission file 800 with use of the supplementary image clipping information 603 that was acquired (S903).

Next, a reduced-size supplementary image region is generated by reducing the size of the supplementary image region extracted in S903 to the horizontal and vertical number of pixels indicated by the supplementary image size information 602 that was acquired in S902 (S904). The reduced-size supplementary image region generated in S904 is compressed with JPEG or the like using the supplementary image compression parameters 604 that were acquired in S902, and the compressed image data is the reproduced supplementary image data. After being generated, the reproduced supplementary image data is stored as a reproduced supplementary image file for the corresponding supplementary image (S905).

In S906, a determination is made as to whether the processing of S902 to S905 has been performed for all the supplementary images described in the supplementary image reproduction information file 600. If a determination is made that such processing has ended for all the supplementary images, the procedure proceeds to S907, and if a determination is made that a supplementary image that has not been processed exists, the procedure returns to S902.

When the processing up to this point ends, the number of reproduced supplementary image files that have been generated is equal to the number of supplementary images. Lastly, a single file is generated by attaching the reproduced supplementary image files as supplementary image data to the end of the transmission file 800 in the order in which they were created. The file generated at this time corresponds to a third file, and the generation processing here corresponds to third generation processing. According to the above operations, the supplementary image data is added to the transmission file 800 shown in FIG. 8, and thus the format returns to that of the file storing multiple images 300 shown in FIG. 3. Also, the reproduced supplementary image data is not always completely the same as the original due to the influence of calculation errors and the like, and therefore the supplementary image data pointers for the supplementary images in the reproduced file are updated to the correct values (S907), and thereafter the processing performed in the image server 110 that is the transmission destination ends.

According to the above processing, sending reproduction information for supplementary image data to the transmission destination enables reducing the amount of data that is transferred during file transmission, while holding information regarding the size and quality of the supplementary image data to be included in the file that is to be obtained at the transmission destination. Note that in the present embodiment, the format of the main image data and the supplementary image data stored in the file storing multiple images 300 may be a general image data format other than JPEG. Also, if an uncompressed image format such as the BMP format is used, there is no particular need for compression parameters.

Although the header portion of the transmission file 800 is not modified in the present embodiment, a configuration is possible in which the supplementary image data number in the header is set to “0”, and the transmission file 800 is generated as a file in which only a main image exists. In the case in which the header is modified at the time of transmission, the header information is returned to the correct value at the time of file reproduction at the transmission destination.

Also, although the supplementary image reproduction information file 600 is used for transferring supplementary image reproduction information in the present embodiment, the supplementary image reproduction information may be incorporated in the transmission file 800. In other words, it is only necessary for the configuration to be such that supplementary image reproduction information can be acquired at the transmission destination.

Also, if the supplementary image compression parameters 604 are the same as the compression parameters of the main image, the parameters of the main image may be used as the supplementary image compression parameters 604. Specifically, in S510, the compression parameters in the JPEG header stored in the main image data are compared with the compression parameters stored in the JPEG header in the supplementary image data. If the compression parameters are the same, an ID indicating that the compression parameters are the same as those of the main image data is set in the supplementary image compression parameters 604 of the supplementary image reproduction information file 600. In the processing of S905 at the transmission destination, if an ID indicating that the compression parameters are the same as those of the main image data is set in the supplementary image compression parameters 604, it is sufficient to acquire the compression parameters in the JPEG header of the main image data, and compress the reduced-size supplementary image region with JPEG according to the acquired parameters. In this way, sharing the compression parameters enables further reducing the amount of data that is transmitted.

The present embodiment is highly effective in cases such as where the transmission (or transfer) speed is slow and the communication cost is high. Accordingly, the transmission method of the present embodiment and a normal transmission method may both be used when appropriate depending on the speed of the communication route and cost. Specifically, the transmission method of the present embodiment is used if the transmission speed is slow, and if the communication cost is high. Also, for example, the communication route is detected before transmission, and the normal transmission method is used if the communication route is a wired LAN or USB, and the transmission method of the present embodiment is used if the communication route is a wireless LAN or IrDA. Also, focusing on communication cost, a configuration is possible in which the communication route is detected before transmission, the transmission method of the present embodiment is used in the case of transmission from a mobile phone, and the normal transmission method is used in the case of transmission from a device other than a mobile phone.

Also, a configuration is possible in which at the time of generating the file storing multiple images 300, the name of the size-reduction algorithm used in the creation of the supplementary image data from the main image data is stored as supplementary image information in the header part 31 of the file storing multiple images 300, likewise to the compression parameters. The name of the size-reduction algorithm is transmitted within the supplementary image reproduction information file 600, and if processing using the size-reduction algorithm having this name can be performed in the size-reduction processing in S904 at the transmission destination, processing using the size-reduction algorithm having this name is performed. In this case, there are many general examples of size-reduction algorithms, such as the nearest neighbor method, the bilinear method, and the bicubic method, and the output results differ slightly depending on the differences between these algorithms. For this reason, by performing processing that conforms to the size-reduction processing used when generating the supplementary image data in the file storing multiple images 300 in the transmission source, it is possible to create reproduced supplementary image data that is closer to the original supplementary image data.

Also, although an exemplary case is described in the present embodiment in which one file, namely the file storing multiple images 300 is transmitted, in the case in which a plurality of files storing multiple images 300 are to be transmitted, the processing described in the present embodiment is repeated for each file that is to be transmitted. Here, a configuration is possible in which transmission is performed using the transmission method of the present embodiment only if the number of files storing multiple images 300 that are to be transmitted is greater than or equal to a certain number, and otherwise transmission is performed using the normal transmission method. Also, a configuration is possible in which the transmission method of the present embodiment is used only if the total size of the supplementary image data pieces stored in the file storing multiple images 300 that is to be transmitted is greater than or equal to a certain size, and otherwise the normal transmission method is used. Furthermore, a configuration is possible in which the transmission method of the present embodiment is used only if the total size of the supplementary image data pieces with respect to the size of the main image data is greater than or equal to a certain ratio, and otherwise the normal transmission method is used.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-142709, filed Jun. 15, 2009, which is hereby incorporated by reference herein in its entirety.

What is claimed is:

1. An information processing apparatus including a transmission unit configured to transmit to a peripheral apparatus a file containing image data expressing an image and supplementary image data expressing a supplementary image generated based on a region that is at least a portion of the image, the information processing apparatus comprising:
a storage unit configured to store the file;
a second generation unit configured to compare the image data and the supplementary image data and detect which region of the image the supplementary image was generated based on, and generate a second file containing information indicating the region that was detected and a size of the supplementary image; and
a first generation unit configured to generate a first file by deleting the supplementary image data from the file,
wherein the transmission unit transmits the first file and the second file instead of transmitting the file.

2. The information processing apparatus according to claim 1, wherein the region is a rectangular region.

3. The information processing apparatus according to claim 2, wherein the supplementary image is an image expressing the rectangular region, or an image obtained by performing size-reduction on the image expressing the rectangular region.

4. An information processing system comprising an information processing apparatus including a transmission unit configured to transmit to a peripheral apparatus a file containing image data expressing an image and supplementary image data expressing a supplementary image generated based on a region that is at least a portion of the image, and a peripheral apparatus capable of receiving the file transmitted from the transmission unit of the information processing apparatus,
the information processing apparatus comprising:
a storage unit configured to store the file;
a second generation unit configured to compare the image data and the supplementary image data and detect which region of the image the supplementary image was generated based on, and generate a second file containing information indicating the region that was detected and a size of the supplementary image; and
a first generation unit configured to generate a first file by deleting the supplementary image data from the file,
wherein the transmission unit transmits the first file and the second file to the peripheral apparatus instead of transmitting the file, and
the peripheral apparatus comprising:
a reception unit configured to receive the first file and the second file; and
a third generation unit configured to generate the supplementary image data from the image data contained in the first file with use of the information indicating the region and the size of the supplementary image that are contained in the second file, and generate a third file having the same configuration as the file by attaching the supplementary image data to the first file.

5. An information processing method executed in an information processing system comprising an information processing apparatus that transmits to a peripheral apparatus a file containing image data expressing an image and supplementary image data expressing a supplementary image generated based on a region that is at least a portion of the image, and a peripheral apparatus capable of receiving the file transmitted from the information processing apparatus, the information processing method comprising the steps of:
in the information processing apparatus,
comparing the image data and the supplementary image data and detecting which region of the image the supplementary image was generated based on, and generating a second file containing information indicating the region that was detected and a size of the supplementary image;
generating a first file by deleting the supplementary image data from the file; and
transmitting the first file and the second file to the peripheral apparatus instead of transmitting the file, and
in the peripheral apparatus,
receiving the first file and the second file; and
generating the supplementary image data from the image data contained in the first file with use of the information indicating the region and the size of the supplementary image that are contained in the second file, and generating a third file having the same configuration as the file by attaching the supplementary image data to the first file.
